(19) United States
(12) Patent Application Publication
(10) Pub. No.: US 2007/0034008 A1
(43) Pub. Date: Feb. 15, 2007

(54) Monitoring of a glue pattern on a wrapping strip

(75) Inventor: Helmut Voss, Lockstedt (DE)

Correspondence Address: VENABLE LLP, P.O. BOX 34385, WASHINGTON, DC, 20043-9998, US

(73) Assignee: Hauni Maschinenbau AG, Hamburg (DE)

(21) Appl. No.: 11/495,626

(22) Filed: Jul. 31, 2006

(30) Foreign Application Priority Data
Aug. 3, 2005 (DE) 10 2005 037 086.1

(51) Int. Cl. G01H 17/00

(52) U.S. Cl. 73/570

(57) ABSTRACT

An apparatus for determining and/or monitoring a glue quantity or glue mass applied to a wrapping strip of the tobacco-processing industry includes an ultrasound measuring system. The ultrasound measuring system comprises at least two ultrasound generating sources adapted to supply the wrapping strip with ultrasound, at least two ultrasound sensor receiving units adapted to receive the ultrasound signals penetrating the wrapping strip, and a separating wall arranged between at least two of the ultrasound generating sources and/or between at least two of the ultrasound sensor receiving units.

### REFERENCE TO RELATED APPLICATIONS

This application claims priority from German Application No. 10 2005 037 086.1 filed Aug. 3, 2005, the disclosure of which is incorporated herein by reference together with each and every U.S. and foreign patent and patent application mentioned below.

### BACKGROUND OF THE INVENTION

The invention relates to an apparatus for determining and/or monitoring a glue quantity or glue mass applied to a wrapping strip of the tobacco-processing industry, wherein an ultrasound measuring system is provided with at least two ultrasound generating sources for supplying the wrapping strip with ultrasound and with at least two ultrasound sensor receiving units for receiving the ultrasound signals penetrating the wrapping strip. Moreover, the invention relates to a machine of the tobacco-processing industry.

For connecting cigarette filters with tobacco rods, a sheet of tipping paper is normally provided, which encloses the filter on one side and connects one head end of the tobacco rod with the filter on the other side with the overlapping edge. The joining of the filter with the tobacco rod normally occurs through gluing.

European patent application EP-A-1 147 716 describes a device for applying glue to a wrapper material or a wrapping paper strip of a rod-shaped item of the tobacco-processing industry. In order to create a glue pattern with glue-free areas on a wrapping strip, the apparatus has means for interrupting the glue supply to the wrapping paper strip.

With high production speeds on a filter application machine, it can come about that the glue layer is applied too thin to the tipping paper web or holes or breaks form due to process-related malfunctions such as contamination in the gluing system, so that an insufficient connection is ensured between the filter and the tobacco rod.

EP-B-0 418 342 describes an apparatus for ascertaining sufficient moistness of a paper web, wherein the presence of glue on the paper web to be glued can be ascertained by means of a capacitive sensor.

### SUMMARY OF THE INVENTION

Based on this state of the art, it is an object of the invention to provide another option for determining the glue quantity or mass as well as for monitoring the gluing on a wrapping strip of the tobacco-processing industry, in particular in the border area of the wrapping strip.

The above and other objects of the invention are accomplished by the invention wherein according to one exemplary embodiment there is an apparatus for determining and/or monitoring a glue quantity or glue mass applied to a wrapping strip of the tobacco-processing industry, the apparatus comprising: an ultrasound measuring system including: at least two ultrasound generating sources adapted to supply the wrapping strip with ultrasound; at least two ultrasound sensor receiving units adapted to receive the ultrasound signals penetrating the wrapping strip; and a separating wall arranged between at least two of the ultrasound generating sources and/or between at least two of the ultrasound sensor receiving units.

The invention is based on the idea that a deflection of the emitted beams or other artefacts on the ultrasound measuring system, in particular in the border area of the paper web to be checked or the wrapping strip to be checked, can be avoided in an ultrasound measuring system by attaching partition walls or separating walls between two ultrasound sources and/or two ultrasound receivers. With a fixed attachment or arrangement of an acoustic source on a receiver, signals from neighbouring ultrasound transmitters are suppressed or shielded by the separating walls and can be analyzed by a controller or an evaluation device, whereby a particularly reliable measurement of the glue quantity or a monitoring of the glue pattern also in the edge area of the wrapping strip is enabled overall. The ultrasound between an ultrasound transmitter and the corresponding ultrasound receiver is thereby channelled or aligned by the partition walls.

The measurement principle is based on the fact that a portion of the transmitted ultrasonic waves is absorbed by the glued paper web and the unabsorbed portion is available as a measurement signal on the receiving sensor so that the glue quantity of the applied glue is quasi continuously checked and monitored by means of ultrasound. A paper web conveyed and glued at a high transport speed can hereby be examined for gluing flaws. The measurement procedure is, in terms of the applied glue quantity, a direct measurement procedure and is independent of the composition, e.g. the amount of water in the glue. Moreover, vertical paper fluctuations hardly have an effect on the received ultrasonic measurement signals.

The ultrasound is created by at least two transmitter units, for example in the form of piezo elements, and is received by at least two receiver units, for example in the form of piezo-sensitive microphones. In order to continuously monitor the conveyed wrapping strip, the wrapping strip is supplied with ultrasound transversally to the transport direction, wherein the wrapping strip is conveyed between the transmitter unit and the sensor receiving unit. The ultrasound can thereby be arranged in a preferred alignment to the wrapping strip and can scan the wrapping strip. Ultrasound-transmitting piezo elements are arranged on the glued and non-glued side of the wrapping strip. The ultrasonic waves or signals are received by piezo-sensitive microphones or sensors on the respective other side.

The entire width of the wrapping strip is hereby monitored, whereby all widths of the wrapping strip can be measured unformatted with the same measuring system, consisting of a transmitter unit and a sensor receiving unit. The glue quantity of glue tracks of a glue pattern, preferably time-averaged, is measured using the received ultrasonic signals and/or defective areas in the glue pattern are detected.

Furthermore, it is advantageous if at least one ultrasound generating source and/or an ultrasound receiving unit is arranged between two separating walls.

The most reliable measurement results are then given if the separating walls are arranged at predetermined intervals, preferably regular, intervals from each other.

Moreover, it is advantageous if the height of the separating wall or the heights of the separating walls are greater than the heights of the ultrasound generating sources and/or the ultrasound receiving unit. The ultrasonic waves on the transmitter are hereby aligned exactly with the associated receiver so that the receiver does not receive any interfering ultrasonic signals from neighbouring transmitters. If the separating walls are arranged on the receiver, the measurement will be suppressed or largely prevented by the neighbouring transmitters.

The apparatus can be easily cleaned if at least one separating wall or several separating walls are arranged as removable units so that, for purposes of cleaning the ultrasound measuring system, the separating walls can be detached or removed and then repositioned again exactly.

Furthermore, it is advantageous if a cleaning device is provided for the ultrasound measuring system, whereby contamination or a change in the measurements by deposits is avoided.

For this, it is advantageous that the cleaning device is designed as an ultrasound transmitter and/or as a compressed-air device. The ultrasound measuring system or the individual components of the measuring system are hereby effectively cleaned in a simple manner, wherein the design effort can be minimized.

The wrapping strip is preferably guided between the ultrasound generating sources and the ultrasound-receiving units, which are spaced apart. For this, the ultrasound measuring system can be U-shaped or fork-shaped.

Furthermore, the apparatus is characterized in that piezo elements are provided as ultrasound generating sources and/or piezo-sensitive microphones are provided as an ultrasound sensor receiving unit. At least two ultrasound sources, in particular piezo elements, are arranged on one leg of the U shape, and at least two ultrasound sensor receiving units, in particular piezo-sensitive microphones, are arranged on the other leg of the U shape. A larger number of ultrasound-transmitting piezo elements, arranged in an array, is preferred in order to achieve a homogeneous sound field over the entire width of the wrapping strip. An array is also advantageous on the sensor receiving side so that better resolutions can be achieved.

In order to achieve a compensation of the paper thickness or the thickness of the wrapping strip, a second, preferably U-shaped, sensor device with an ultrasound generating source and an ultrasound-receiving unit is provided in front of a glue application unit for the wrapping strip, in terms of the transport direction of the wrapping strip, wherein the second transmitter or receiver unit preferably also has separating walls.

It is also advantageous if an evaluation device is provided for evaluating the received ultrasound signals.

The apparatus is furthermore characterized in that the entire width of the wrapping strip can be monitored by the ultrasound measuring system.

Moreover, the object of the invention is achieved through a machine of the tobacco-processing industry, which is equipped with an apparatus described above in accordance with the invention for determining and/or monitoring a glue quantity or glue mass applied to a wrapping strip of the tobacco-processing industry. In order to avoid repetitions, express reference is made to the above embodiments of the apparatus in accordance with the invention.

### BRIEF DESCRIPTION OF THE INVENTION

The invention is described below, without restricting the general intent of the invention, based on exemplary embodiments in reference to the drawings, whereby reference is expressly made to the drawings with regard to the disclosure of all details according to the invention that are not explained in greater detail in the text. The enclosed schematic drawings illustrate the invention as follows:

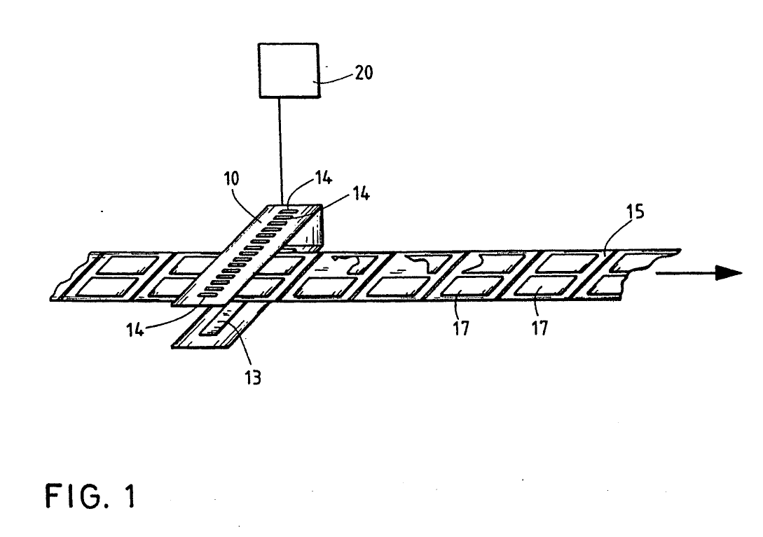

FIG. 1 is a schematic perspective representation of a sensor in accordance with the invention; and

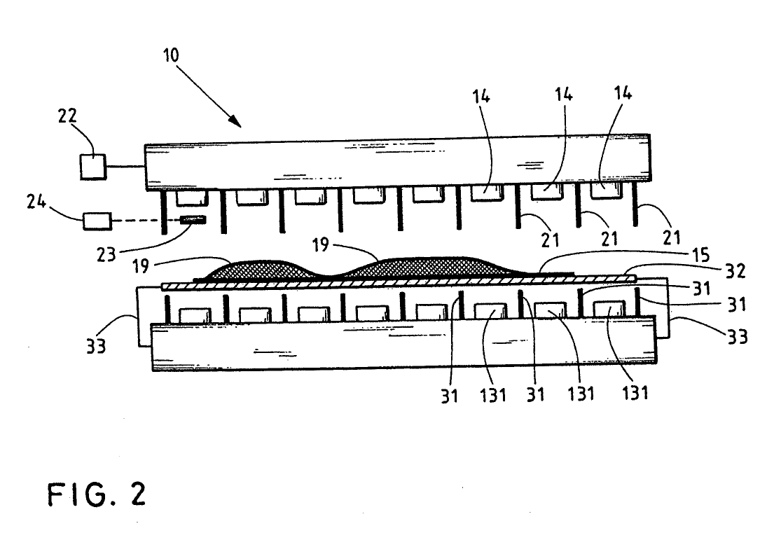

FIG. 2 is a cross-section through an ultrasound measuring system in accordance with the invention.

### DETAILED DESCRIPTION OF THE INVENTION

In the following figures, the same or similar types of elements or corresponding parts are provided with the same reference numbers in order to prevent the item from needing to be reintroduced.

FIG. 1 shows a perspective view of an ultrasound measuring system 10. The ultrasound measuring system 10 is shaped like a fork or a U. A tipping paper web 15 is passed through and transported between the two legs of the U shape. The tipping paper web 15 is provided with a glue pattern of applied glue, which has been applied to the tipping paper web 15 by a gluing unit that is not shown here. The glue pattern has several glue-free areas 17, which are perforated after the cutting of the tipping paper web 15 into tipping patches and after the coiling of the cut tipping patched around filter plugs and tobacco rods with the help of processing units.

The peripheral zones are instrumental in the gluing of the tipping paper on the tobacco rod of the cigarette. A lack of glue on these areas leads to filters that are loose or that fall off; thus, the application of the glue is particularly important. For this reason, more glue is applied in places in the peripheral zone area than in the middle zones of the glue pattern.

Gluing mistakes in the middle zones can cause adhesive problems in the seam area of the filter, which can be indirectly detected by a downstream pneumatic detection system on an inspection drum, so that the cigarette provided with a defectively glued tipping paper can be ejected. The middle zones contain both continuous zones as well as glue-free zones 17.

Depending on the type of glue as well as the shape of the glue application unit or other process parameters, superelevations and thus inhomogeneous distribution of the glue over the width of the tipping paper web 15 can result within the individual glue tracks of the glue pattern.

The glued tipping paper web 15 is guided without being touched through the U-shaped ultrasound measuring system 10. A guiding device or guide not shown here is also provided in order to prevent the fluttering of the paper web or the tipping paper web 15 and to ensure a constant distance from the paper web 15 to the transmitters 131 and receivers 14 of the ultrasound measuring system 10. A transmitting rail 13 with linearly arranged piezo elements for the creation of ultrasonic waves is located on the unglued side. A linear arrangement made up of sensors or piezo-sensitive microphones 14 is located on the opposite, glued side of the tipping paper web 15.

The arrangement of microphones 14 is tuned to the ultrasonic frequency of the transmitting rail 13. Frequencies of over 100 kHz, preferably over 400 kHz, are typically suitable for the identification of the glue quantity or the monitoring of the glue track or also the glue pattern on the tipping paper web 15. The ultrasound created by the piezo elements of the transmitting rail 13 is directed transversally, preferably perpendicularly, to the transport direction. The created ultrasound is scanned through the tipping paper web 15 as well as the overlapping peripheral zones of the tipping paper web 15.

The ultrasound measuring system 10 works in the pulse mode, i.e. the transmitting rail 13 sends a sound pulse so that the arrangement of the microphones 14 registers the intensity of the acoustic pressure received.

Depending on the thickness or mass per unit area of the applied glue on the tipping paper web 15, there is a different quantity or mass profile as well as thickness profile over the width of the tipping paper strip 15. Based on the amplitude changes in the receiving signal over the width of the tipping paper web 15, which is captured by the microphones 14, the amount or mass or the density of the glue will be measured over the width. The ultrasound measuring system 10 is connected to an evaluation device 20 for the evaluation of the received ultrasonic signals.

The transmitting rail 13 and the arrangement of the microphones 24 are designed such that they capture the glue pattern or the glue quantity over the entire width of the tipping paper web 15. In particular, they are designed such that they are wider than the maximum format width of a wrapping strip 15. Numerous widths of a tipping paper web 15 can thereby be captured format-free with the same measuring system 10.

In order to eliminate the effects of the tipping paper web 15 on the measurements, a second ultrasound measuring system, which is also built in accordance with the ultrasound measuring system 10 shown in the drawing, is arranged in front of the glue application unit. This second ultrasound measuring system measures the fluctuations and effects of the thickness of a tipping paper web 15 that has not yet been glued. The second ultrasound measuring system is also connected to the evaluation device 20 so that a compensation of the paper thickness fluctuation occurs through a difference formation of the signals via the difference formation of the two measured ultrasound signals before and after the gluing of the tipping paper web 15.

In order to be able to identify the amount or mass and the quality of the gluing or its temporal development or tendency over a longer period of time and thus to draw conclusions on the adhesive strength of the applied glue, the ultrasounds signals of the sensors are averaged. Glue mistakes or defective areas in the glue pattern are identified through the surpassing or shortfall of a set point for a specified glue quantity by means of an ultrasound system 10 in accordance with the invention.

FIG. 2 shows a cross-section through an ultrasound measuring system 10 in accordance with the invention. The tipping paper web 15 is hereby arranged perpendicular to the plane of projection between the linear arrangement of the microphones 14 and the linear arrangement of the transmitting rail 13 made up of the piezo elements 131.

Each microphone 14 is surrounded by two separating walls 21, whereby ultrasonic signals are suppressed, which are transmitted by the non-opposite-lying piezo element(s) 131. The ultrasound measured at the microphones 14 thus always originates from the associated, opposite-lying piezo element 131. The separating walls 21 are arranged with respective to each other, whereby a comb-shaped structure of the separating walls 21 is created.

FIG. 2 also shows separating walls 31 arranged at regular intervals on the transmitting rail opposite the microphones 14, between each of which a piezo element 131 is arranged. In this arrangement of the separating walls 31, it is also possible to channel or appropriately align the ultrasound transmitted by the piezo elements 131 so that the ultrasound is received on the opposite-lying side by the respective microphone 14.

Moreover, a guide rod 32 is arranged above the piezo elements 131 for guiding and supporting the tipping paper web 15, whereby a fluttering of the guided paper web 15 is avoided. The guide rod 32 is affixed to the transmitting rail via two lateral mounts 33.

The arrangement of the separating walls 21 on the receiving side and/or the arrangement of the separating walls 31 on the transmitting side results in exact measurements of the density or an exact identification of the gluing pattern 19 on the tipping paper web 15. The ultrasound is aligned perpendicular to the conveyed tipping paper web 15 and concentrated between a pair made up of a piezo element 131 and a microphone 14 by the separating walls 21 or 31.

In particular, the measurements or the receipt of the ultrasonic signals are more exact due to the separating walls 21 and/or 31, since deflections of the ultrasound on the outer edges of the tipping paper web 15 or other artefacts in the peripheral area of the tipping web are suppressed or eliminated.

The separating walls 21 or 31 are preferably designed as a compact unit, wherein the unit can be removed from the receiving rail or the transmitting rail for cleaning purposes. After removing the separating walls 21 or 31, the microphones and the piezo elements are freely accessible for the removal of dust particles.

Moreover, it is possible to clean the ultrasound measuring system 10 mechanically, whereby a removal of the separating walls 21 or 31 arranged in a web-like or comb-like manner is not required. An ultrasound actor 22 is attached for cleaning in order to give a high-energy ultrasound pulse to the microphones 14 and the separating walls 21 arranged between them.

As an alternative or in addition to the ultrasound actor 22, the cleaning device can be designed using an air nozzle 23, which is supplied with compressed air from a compressed-air source 24. The dust particles in the ultrasound measuring system or on the separating walls 21 are hereby blown away.

The invention has been described in detail with respect to referred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. An apparatus for determining and/or monitoring a glue quantity or glue mass applied to a wrapping strip of the tobacco-processing industry, the apparatus comprising:
an ultrasound measuring system including:
at least two ultrasound generating sources adapted to supply the wrapping strip with ultrasound;
at least two ultrasound sensor receiving units adapted to receive the ultrasound signals penetrating the wrapping strip; and
a separating wall arranged between at least two of the ultrasound generating sources and/or between at least two of the ultrasound sensor receiving units.

2. The apparatus according to claim 1, wherein at least one of the ultrasound generating sources and/or at least one of the ultrasound receiving units is arranged between two separating walls.

3. The apparatus according to claim 1, wherein the separating walls are arranged at predetermined intervals.

4. The apparatus according to claim 3, wherein the predetermined intervals are regular intervals.

5. The apparatus according to claim 1, wherein the separating walls have a height that is greater than the height of the ultrasound generating sources and/or the ultrasound receiving units.

6. The apparatus according to claim 1, wherein at least one of the separating walls is arranged in a removable manner.

7. The apparatus according to claim 1, further including a cleaning device operative to clean the ultrasound measuring system.

8. The apparatus according to claim 6, the cleaning device comprises an one of an ultrasound transmitter or a compressed-air device.

9. The apparatus according to claim 1, wherein the ultrasound generating sources and the ultrasound sensor receiving units are arranged to have the wrapping strip guided between the ultrasound generating sources and the ultrasound sensor receiving units.

10. The apparatus according to claim 1, wherein the ultrasound generating sources comprise piezo elements.

11. The apparatus according to claim 1, wherein the ultrasound sensor receiving units comprise piezo-sensitive microphones.

12. The apparatus according to claim 1, further comprising an evaluation device coupled to the ultrasound measuring system to evaluate the received ultrasonic signals.

13. The apparatus according to claim 1, wherein the ultrasound measuring system is adapted to measure the entire width of the wrapping strip.

14. A method of determining and/or monitoring a glue quantity or glue mass applied to a wrapping strip of the tobacco-processing industry, comprising utilizing the apparatus according to claim 1.

15. A machine of the tobacco-processing industry including an apparatus according to claim 1 for determining and/or monitoring a glue quantity or glue mass applied to a wrapping strip of the tobacco-processing industry.
